(19) United States
(12) Patent Application Publication
(10) Pub. No.: US 2019/0114920 A1
(43) Pub. Date: Apr. 18, 2019

(54) AUTOMATED VEHICLE SAFETY SYSTEM THAT PROTECTS PEDESTRIANS

(71) Applicant: Aptiv Technologies Limited, St. Michael (BB)

(72) Inventors: Brian R. Hilnbrand, Mountain View, CA (US); Michael H. Laur, Mission Viejo, CA (US); Divya Agarwal, Sunnyvale, CA (US)

(21) Appl. No.: 15/783,060

(22) Filed: Oct. 13, 2017

(51) Int. Cl. G08G 1/16; G08G 1/0967

(52) U.S. Cl. CPC G08G 1/166; G08G 1/0967

(57) ABSTRACT

A safety system for an automated vehicle includes an object-detector and a controller. The object-detector is operable to detect an approaching-vehicle proximate to a host-vehicle. The controller is in communication with the object-detector. The controller is configured to operate the host-vehicle to obstruct a travel-path of the approaching-vehicle when unimpeded travel by the approaching-vehicle on the travel-path may result in injury to a pedestrian.

### TECHNICAL FIELD OF INVENTION

This disclosure generally relates to a safety system for an automated vehicle, and more particularly relates to a system that operates a host-vehicle to obstruct a travel-path of an approaching-vehicle when unimpeded travel by the approaching-vehicle on the travel-path may result in injury to a pedestrian.

### BACKGROUND OF INVENTION

It is recognized that are situations when a third-party can foresee an impending collision between a pedestrian and an approaching vehicle.

### SUMMARY OF THE INVENTION

In accordance with one embodiment, a safety system for an automated vehicle is provided. The system includes an object-detector and a controller. The object-detector is operable to detect an approaching-vehicle proximate to a host-vehicle. The controller is in communication with the object-detector. The controller is configured to operate the host-vehicle to obstruct a travel-path of the approaching-vehicle when unimpeded travel by the approaching-vehicle on the travel-path may result in injury to a pedestrian.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a safety system for automated vehicle in accordance with one embodiment; and

FIG. 2 is a scenario encountered by the system of FIG. 1 in accordance with one embodiment.

### DETAILED DESCRIPTION

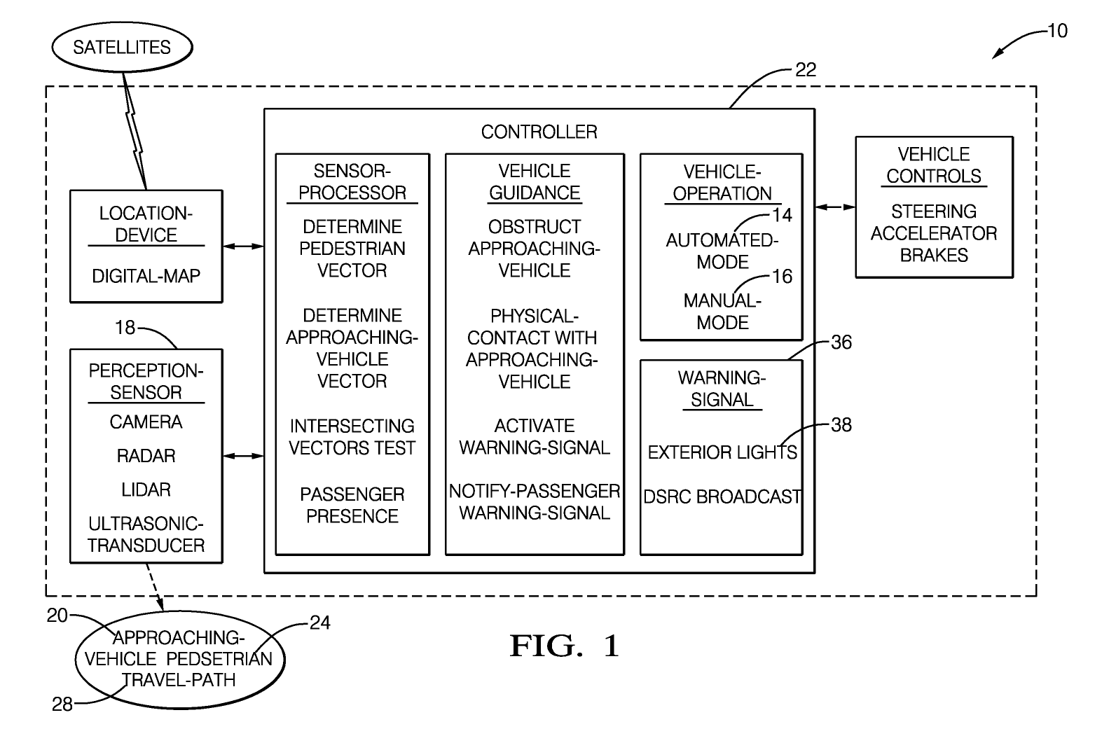

FIG. 1 illustrates a non-limiting example of a safety system 10, hereafter referred to as the system 10, which is generally intended for use by an automated vehicle, e.g. a host-vehicle 12. As used herein, the term automated vehicle may apply to instances when the host-vehicle 12 is being operated in an automated-mode 14, i.e. a fully autonomous mode, where a human-operator (not shown) of the host-vehicle 12 may do little more than designate a destination in order to operate the host-vehicle 12. However, full automation is not a requirement. It is contemplated that the teachings presented herein are useful when the host-vehicle 12 is operated in a manual-mode 16 where the degree or level of automation may be little more than providing an audible or visual warning to the human-operator who is generally in control of the steering, accelerator, and brakes of the host-vehicle 12. For example, the system 10 may merely assist the human-operator with steering or braking on an as needed basis.

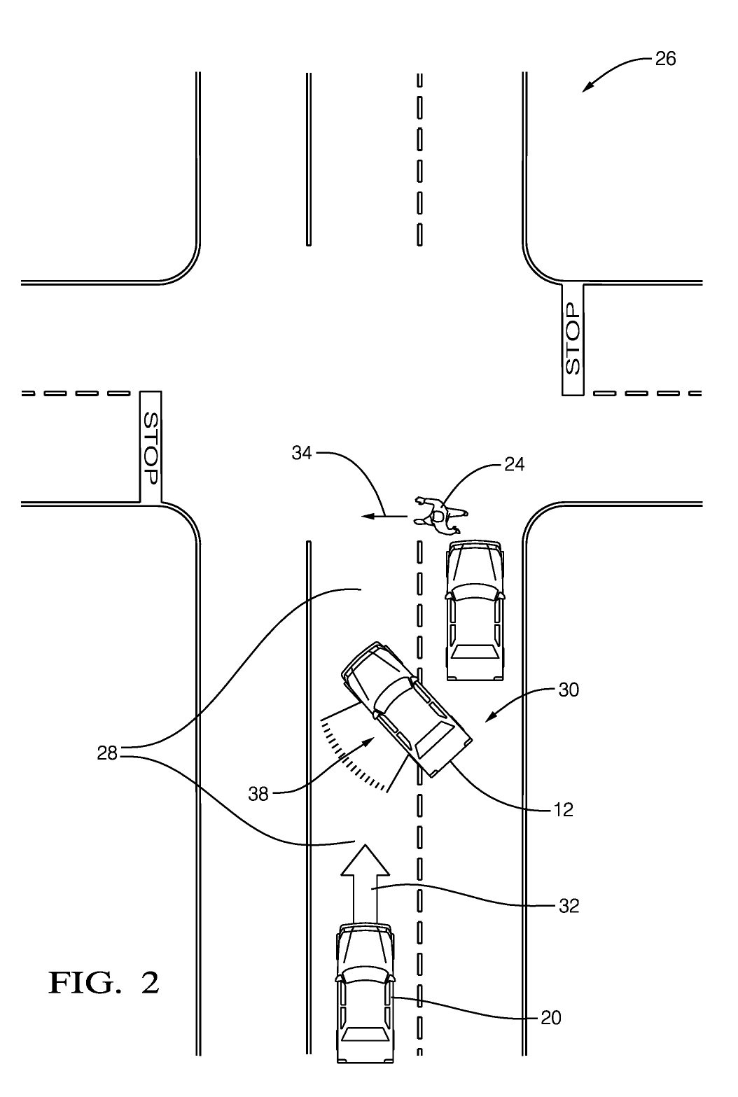

The system 10 includes an object-detector 18 that is operable to detect an approaching-vehicle 20 (see also FIG. 2) proximate to a host-vehicle 12. The object-detector 18 may consist of or include a camera, a radar, a lidar, an ultrasonic-transducer, or any combination thereof. Those in the vehicle perception sensor arts will recognize that there are many varieties of commercially available devices suitable to be used to form the object-detector 18. While FIG. 1 might be interpreted by some to suggest that all of the devices must be co-located, this is not a requirement. Indeed, as will become apparent in the description that follows, it may be preferable that the devices be distributed at different locations about the host-vehicle 12. Furthermore, it is expected that there will be multiple instances of a particular type of device, e.g. multiple radars mounted at different locations on the host-vehicle 12 in order to have different fields-of-view about the host-vehicle 12.

The system 10 includes a controller 22 in communication with the object-detector 18. The controller 22 may include a processor (not specifically shown) such as a microprocessor or other control circuitry such as analog and/or digital control circuitry including an application specific integrated circuit (ASIC) for processing data as should be evident to those in the art. The controller 22 may include memory (not specifically shown), including non-volatile memory, such as electrically erasable programmable read-only memory (EEPROM) for storing one or more routines, thresholds, and captured data. The one or more routines may be executed by the processor to perform steps for determining if the approaching-vehicle 20 represents a threat to, for example, a pedestrian 24 (see also FIG. 2) or a vehicle transporting passengers, based on signals received by the controller 22 from the object-detector 18 as described herein.

FIG. 2 illustrates a non-limiting example of a scenario 26 where the approaching-vehicle 20 may not detect the presence of the pedestrian 24 prior to crossing a travel-path 28 of the approaching-vehicle 20. It is noted that prior to the instant depicted in FIG. 2, the host-vehicle 12 was in an adjacent-lane 30 next to the lane identified as the travel-path 28, so at that prior time the forward movement of the approaching-vehicle 20 was unobstructed. At that prior time, the object-detector 18 of the host-vehicle 12 detected the presence of the pedestrian 24 and the approaching-vehicle 20, and the controller 22 was able to predict or foresee that the pedestrian 24 and the approaching-vehicle 20 would likely collide if both stayed on their present trajectories. For example, the controller 22 may determine a vehicle-vector 32 that indicates a speed and direction of travel of the approaching-vehicle 20, and determine a pedestrian-vector 34 that indicates a speed and direction of travel of the pedestrian 24. The controller 22 may then perform an intersecting vectors test to determine if the vehicle-vector 32 and the pedestrian-vector 34 suggest that a collision of the pedestrian 24 and the approaching-vehicle 20 is likely.

In order to prevent this predicted or forecasted collision, the controller 22 may be configured to operate the host-vehicle 12 to obstruct a travel-path 28 of the approaching-vehicle 20 when unimpeded travel by the approaching-vehicle 20 on the travel-path 28 may result in injury to a pedestrian 24. That is, as suggested in FIG. 2, the host-vehicle 12 may move into the travel-path 28 which will block or obstruct the forward movement of the approaching-vehicle 20, and optionally broadcast a warning to the approaching-vehicle 20, thereby affording some protection to the pedestrian 24. It is recognized that such an action by the host-vehicle 12 (i.e. action by the controller 22 or the system 10 in the operation of the host-vehicle 12) may place a passenger/operator of the host-vehicle 12 as some risk of injury, so the controller 22 may be optionally configured to operate the host-vehicle 12 to obstruct a travel-path 28 of the approaching-vehicle 20 only when the host-vehicle 12 is not occupied by a passenger or operator (not shown). Accordingly, the host-vehicle 12 may be equipped with interior sensors suitable to determine a passenger presence in the host-vehicle 12.

However, it is recognized that the probability of a collision between the host-vehicle 12 and the approaching-vehicle 20 due to the host-vehicle 12 moving into the travel-path 28 can be estimated, and if the probability of such a collision is less than some threshold, the system 10 or controller 22 may be configured to proceed with obstructing the travel-path 28 even if passenger is present in the host-vehicle 12. If such an action is selected, it is contemplated that the host-vehicle 12 would be equipped to notify the passenger with an audible and/or visual warning of the situation. That is, the controller 22 may be configured to notify a passenger of the host-vehicle 12 when unimpeded travel by the approaching-vehicle 20 on the travel-path 28 may result in injury to a pedestrian 24. It is contemplated that the pedestrian 24 could be or include a baby in a baby carriage (not specifically shown in the drawings) being pushed in front of a pedestrian 24, or a bicyclist or skateboarder in a designated pedestrian zone.

It is recognized that there may be circumstances when the only way to protect the pedestrian 24 would be to obstruct the travel-path 28 even though a collision between the approaching-vehicle 20 and the host-vehicle 12 was highly likely. That is, the controller 22 may be configured to operate the host-vehicle 12 to initiate physical-contact with the approaching-vehicle 20 to prevent injury to the pedestrian 24.

It may be advantageous if the host-vehicle 12 is configured to emit or broadcast some sort of a warning-signal 36 when the host-vehicle 12 is about to or is in the process of taking action to obstruct the travel-path 28. The warning-signal 36 may be provided by exterior-lights 38 arranged along the side of the host-vehicle 12, i.e. lights other than known brake/turn-signal indicator lights commonly found on vehicles. Alternatively, or in addition to the exterior-lights 38, the host-vehicle 12 may be equipped with infrastructure communication (V2I) and/or vehicle-to-vehicle (V2V) communication devices such as a dedicated-short-range-communications (DSRC) transceiver that can broadcast a message that the host-vehicle 12 is taking action to protect the pedestrian 24. That is, the controller 22 may be configured to activate the warning-signal 36 when unimpeded travel by the approaching-vehicle 20 on the travel-path 28 may result in injury to the pedestrian 24. The communications can be received by another vehicle or by the infrastructure. When received by the infrastructure additional warnings can be initiated from infrastructure components such as a safety siren, flashing lights, or a visually projected keep-out-zone in front of the pedestrian.

Accordingly, a safety system for an automated vehicle (the system 10), a controller 22 for the system 10, and a method of operating the system 10 are provided. The system is generally configured to make use of a host-vehicle 12 to provide physical protection to a pedestrian 24 who is not a passenger/occupant of the host-vehicle 12.

While this invention has been described in terms of the preferred embodiments thereof, it is not intended to be so limited, but rather only to the extent set forth in the claims that follow.

1. A safety system for an automated vehicle, said system comprising:
an object-detector operable to detect a pedestrian and an approaching-vehicle proximate to a host-vehicle, and
a controller in communication with the object-detector, wherein the controller is configured to operate the host-vehicle to move the host-vehicle to obstruct a travel-path of the approaching-vehicle when unimpeded travel by the approaching-vehicle on the travel-path may result in injury to a pedestrian.

2. The system in accordance with claim 1, wherein the controller is configured to operate the host-vehicle to obstruct a travel-path of the approaching-vehicle only when the host-vehicle is not occupied by a passenger.

3. The system in accordance with claim 1, wherein the controller is configured to operate the host-vehicle to initiate physical-contact with the approaching-vehicle to prevent injury to the pedestrian.

4. The system in accordance with claim 1, wherein the controller activates a warning-signal when unimpeded travel by the approaching-vehicle on the travel-path may result in injury to the pedestrian.

5. The system in accordance with claim 1, wherein the controller is configured to notify nearby infrastructure when unimpeded travel by the approaching-vehicle on the travel-path may result in injury to the pedestrian.

6. The system in accordance with claim 1, wherein the controller is configured to notify nearby vehicles proximate to the pedestrian when unimpeded travel by the approaching-vehicle on the travel-path may result in injury to the pedestrian.

7. The system in accordance with claim 1, wherein the controller is configured to notify a passenger of the host-vehicle when unimpeded travel by the approaching-vehicle on the travel-path may result in injury to a pedestrian.
